(19) United States
(12) Patent Application Publication
(10) Pub. No.: US 2011/0095561 A1
(43) Pub. Date: Apr. 28, 2011

(54) Folding roof cover for vehicles

(76) Inventors: Xingkang Li, Worcester, MA (US); Qiang Li, Toronto (CA); Xingjian Li, Wuhu (CN)

(21) Appl. No.: 12/589,388

(22) Filed: Oct. 23, 2009

(51) Int. Cl. B62D 25/06

(52) U.S. Cl. 296/136.13

(57) ABSTRACT

A center foam strip has a series of transverse fold lines separating the strip into panels which fold onto each other in an accordion pattern for storage. A soft fabric waterproof cover material is attached to the center foam strip to hang down the sides of the vehicle to be closed in the vehicle doors shading the side windows. The cover material and center foam strip are sewn together to conform to the shape of the top of a particular vehicle with the foam strip covering the roof, windshield, and rear window. The center foam strip and surrounding soft fabric are held in place by the trunk lid, doors, and windshield wipers.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to removable protective vehicle covers and particularly to a folding vehicle roof cover which comprises an accordion folding center foam strip with soft fabric waterproof cover material attached to hang down the sides of the vehicle, the cover material and center foam strip sewn together to conform to the shape of the top of a particular vehicle with the center foam strip covering at least a large center portion of the vehicle roof, windshield, and back window, the cover held onto the vehicle by the doors, trunk lid and windshield wipers, wherein the foam can be folded in accordion folds with the very light soft fabric folded around the folded up foam or over the foam prior to folding all into a neat compact rectangular stack for storage inside a bag or box.

2. Description of Related Art Including Information Disclosed Under 37 CFR 1.97 and 1.98

From the earliest days of vehicles, vehicle operators have contended with the elements. Winter brings snow or frost covered windows. The summer sun degrades the interior of a vehicle and turns the passenger compartment into an oven. Sunshades are constructed to fit on the dashboard inside the windshield to shield the interior from direct sunlight. To overcome these elements, vehicle covers have long been known consisting of fabric or plastic shaped to the form of the particular vehicle. This cover may be stored in the trunk of the vehicle in a folded state, and then taken out and spread over the vehicle to provide protection. Most of the exterior covers are very cumbersome and difficult to install on the vehicle and difficult to fold up for storage. They often hook under the bumpers and attempt to cover the whole vehicle, which is unnecessary, since the driver and passenger compartment, windshield, rear window and roof are the primary areas needing to be covered and all the windows shaded against sunlight. Prior art devices do not adequately solve this problem since they fail to provide a simple easy to install and remove covering for the driver and passenger compartment.

U.S. Patent Application #20060061132, published Mar. 23, 2006 by Sua-an, claims a portable device for shielding vehicles from snow during snow storm, consisting of several detachable members with legs and supports which, when assembled, form a roof-like structure resembling a modified cot. The device, spanning the whole length of the vehicle being shielded from the front to the rear, has snow-shielding materials that are either permanently attached to each detachable framed members, or simply superimposed and properly secured on top of the whole device.

U.S. Pat. No. 6,997,503, issued Feb. 14, 2006 to Fukagawa, is for an automobile cover with fold line portions for guiding folding which are formed on a cover body such that the fold line portions extend in the longitudinal direction of the cover body, the cover body is configured to be foldable along the fold line portions, and a plurality of core members are arranged between the fold line portions and left and right longitudinal-side edges of the cover body in a spaced-apart manner in the longitudinal direction. FIG. 6 shows an embodiment which only covers the roof and window of a vehicle.

U.S. Pat. No. 6,318,426, issued Nov. 20, 2001 to Thomas, illustrates a weather blanket apparatus and associated method for protecting an object from the effects of inclement weather. In one aspect, the invention provides an apparatus comprising a cover which has a central portion and a skirt portion. The central portion further comprises a plurality of pad members which are disposed about the central portion to allow an efficient and convenient method for folding the apparatus. The skirt portion further comprises webbing and eyelets which are used to secure the apparatus to an object in the presence of inclement weather.

U.S. Pat. No. 5,429,406, issued Jul. 4, 1995 to Huang, claims a folding sun shield for motor vehicles including an upper cover having a rectangular portion, a first enlarged portion at a short side of the rectangular portion, a second enlarged portion at another short side of the rectangular portion, the first and second enlarged portions being formed at an outer side with a pocket in which is fitted a magnet, the rectangular portion having two rods at both long sides, each of the rods having a smaller diameter at an outer end, a lower cover having a rectangular central portion, a first flap at a long side of the rectangular central portion, and a second flap at another long side of the rectangular central portion, and four fixing blocks fastened on the lower cover and provided with a magnet at a bottom thereof, each of the fixing blocks having a horizontal slot receiving the outer end of each of the rods.

U.S. Pat. No. 5,275,460, issued Jan. 4, 1994 to Kraus, provides a protective cover for a vehicle formed of a sheet of protective material having a plurality of magnetic portions distributed at intervals throughout the sheet to secure the cover to the vehicle. The sheet is pleated or otherwise adapted to be disposed in a closed storage configuration. Adjacent magnets correspond spatially to one another so as to be magnetically attracted to one another when the sheet is folded or otherwise disposed in its storage configuration. Adjacent pairs of magnets are further separated from subsequent pairs of magnets to minimize overlap of the magnets and corresponding width of the folded sheet. Preferably, the sheet is formed of a plastic material, such as a non-wettable polyethylene material. Further, to adequately protect the vehicle from sunlight, the sheet should have an optical opacity of at least 80%. The invention is attached to a vehicle by initially attaching a portion of the cover to a portion of the vehicle using at least one of the plurality of magnets. Further portions are secured to the vehicle as the cover is placed over the vehicle. Thus, the sheet-like protective cover is initially provided in a closed storage configuration and further portions of the vehicle are covered as the cover is opened.

U.S. Pat. No. 4,889,171, issued Dec. 26, 1989 to Minimo, shows a foldable collapsible protective canopy useful as both a sunshade and frost shield for motor vehicles which is made of a sheet of corrugated cardboard, laminated cardboard, vinyl, leather, nylon, plastic, synthetic, or combinations thereof, or any other material in which fold line impressions, indentations or creases can be made to define parallel folds that can be stretched and compressed like the bellows of an accordion, the sheet including a center portion and two side portions provided with belts on opposite ends of the sheet for securing the canopy to a car body. The sheet is alternately foldable to a compact package for convenient handling and storage.

U.S. Pat. No. 4,951,993, issued Aug. 28, 1990 to Taboada, claims a reversibly expandable vehicle cover comprising a generally rectangular cover body which is folded along transverse folding scores into an accordion pleated hinged series of panels terminating in front and end panels. Extending slidably through receiving openings in the panels and extending beyond the front and rear end panels are adjustable length elastomeric guide cords that fasten at the front and rear ends of the cover body with end panel cords that are themselves fastened by one end to the front and rear end panels of the cover body. Upon extending the cover over the vehicle, the cover is secured to the front and rear ends of the vehicle by couplers associated with the termini of the cords.

U.S. Pat. No. 5,413,396, issued May 9, 1995 to Poznansky et al, describes a protective cover for a motor vehicle that includes a number of stiff rectangular panels connected along their long sides by flexible joints, which permits the cover to be folded into a close stack, to be stored inside the baggage compartment of the motorcar and to be pulled out and to be stretched over the body of the motorcar. The strip is provided with a mechanism for attaching its near end to the inside of the baggage compartment and a mechanism for attaching its far end to the front of the motorcar. The cover further includes two lengths of strip or string having their two ends attached to points proximate two corners of each pair of panels, the strip being of a length commensurate with the distance between the points on the panels in the fully stretched state of the cover. The cover further includes elastic members connecting the centers of each two lengths of strip or string adapted to pull the two strips or strings towards the center line of the cover and thereby pull each pair of panels into mutual contact and all the panels of the cover into a close stack.

U.S. Pat. No. 5,690,376, issued Nov. 25, 1997 to Leidal, discloses a shade cover for a motor vehicle, which is usable when the motor vehicle is in operation as well as parked or in storage. The cover includes a rigid panel with a top surface, a bottom surface, a body portion, and an edge portion and has an area greater than the area of the vehicle's roof. The cover further includes a securing member for attaching the panel in a spaced relationship and at its bottom surface to the motor vehicle's roof. A reflective outer layer extends continuously across the top surface throughout the area of the panel. The body portion of the panel has an area substantially equal to the area of the vehicle's roof and presents the periphery from which the edge portion extends angularly outwardly and downwardly for providing shade to the vehicle's interior. At least a portion of the edge portion is transparent to allow a passenger of the vehicle to see therethrough. The cover also includes a ventilating louver member formed in the panel.

U.S. Pat. No. D339,781, issued Sep. 28, 1993 to Hassan, indicates the ornamental design for cover for shutting off sunshine on roof of car.

U.S. Pat. No. 5,087,092, issued Feb. 11, 1992 to Antopolsky et al, puts forth a cover for a motor vehicle which includes a panel of still sheet material having a length and width sufficient at least to cover the vehicle roof and formed with a plurality of longitudinal fold lines to permit folding it in an accordion fashion and thereby to adjust its width to the width of the vehicle roof to which it is applied, and a plurality of anchoring members extending from opposite sides of the panel for anchoring it to the vehicle roof when applied thereover.

U.S. Pat. No. 4,925,234, issued May 15, 1990 to Park et al, shows a length adjustable, trunk stowable protective car cover which is shown in FIGS. 2a and 2b to be folded in an accordion style. The device is formed from an elongated sheet of flexible weatherproof material having a front end portion releasably connectable to the front end of an automobile, a longitudinally intermediate portion adapted to overlie and shield essentially the entire upper side surface of the automobile, and a rear end portion adapted to extend into the trunk between the rear trunk lid edge and the opposing trunk wall portion which it closes against. Closure of the trunk thus clamps a back end of the cover sheet in place to firmly anchor the cover sheet in place in its operative position. An elongated longitudinal slot in the rear end portion of the cover sheet permits the hook portion of the trunk latch to extend through the cover sheet to permit unimpeded locking and unlocking of the trunk. A fastening structure is provided to adjustable secure the rear end portion of the cover sheet within the trunk in a manner permitting selective variation in the effective covering length of the sheet. The sheet may be conveniently stowed in a longitudinally folded orientation within the trunk and then unfolded over the top of the automobile. To facilitate such folding and unfolding, a grab bar is transversely secured to the front end of the sheet and a spaced series of transverse stays are suitably secured to a longitudinally intermediate portion thereof.

U.S. Pat. No. 4,842,324 issued Jun. 27, 1989 to Carden, shows a cover for the cab portion of an automobile to prevent the interior thereof from heating up when left standing in the sun. The cover comprises a four sided structure. When the cover is placed over the roof of an automobile, a tubular member on the bottom of the front portion thereof which lies over the windshield has the windshield wipers placed thereover and pockets formed on either side thereof are snugly fitted over external side view mirror units typically provided on an automobile. A rear tubular member on the bottom of the back portion of the cover which lies over the rear window is inserted into the opening provided on the hinged end of the open lift door of the trunk of the automobile. Upon pulling the rear tubular member into the trunk and then closing and locking the lift door, the cover is tautly held over the roof in a secure manner. The cover is further held on the cab portion by providing self fasteners for holding a portion of the cover lying over one of the side doors which enables this portion including the side pocket thereon to be freed so that a person can enter the automobile and manipulate the window on the opposite side door to trap a short tubular member attached on the undersurface of the cover. Upon leaving the automobile, the side pocket can again be fitted over the external side view mirror unit and the cover portion refastened to the rest of the cover.

What is needed is a covering and shading device for the driver and passenger compartment protecting the outside of the windshield, rear window, and roof and shading all the windows in a simple covering which is easy to install and remove and fold up for storage.

### BRIEF SUMMARY OF THE INVENTION

An object of the present invention is to provide a covering and shading device for the driver and passenger compartment protecting the outside of the windshield, rear window, and roof and shading all the windows in a simple covering which is easy to install and remove and fold up for storage.

In brief, the folding car top cover of the present invention comprises a center foam strip with a series of transverse fold lines separating the center foam strip into panels which fold onto each other in an accordion pattern. A soft fabric waterproof cover material is attached to the center foam strip to hang down over the side windows of the vehicle. The foam may be folded along the fold lines into a neat compact rectangular stack having the very light soft fabric folded over the folded foam stack or over the foam prior to folding for storage inside a bag or box. The cover material and center foam strip are sewn together to conform to the shape of the top of a particular car. The center foam strip and surrounding soft fabric are held in place by the trunk lid, doors, and windshield wipers.

An advantage of the present invention is that it folds and unfolds easily and quickly and is easily installed on a vehicle and removed from a vehicle by a single person in a short time.

Another advantage of the present invention is that it is inexpensive and easy to manufacture.

A further advantage of the present invention is that it is very thin and lightweight and stores compactly.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the vehicle roof cover of the present invention showing the center foam strip and downwardly extending covering material and back securing strip;

FIG. 2 is a perspective view of the vehicle roof cover of the present invention showing the center foam strip and downwardly extending covering material installed on a four door car;

FIG. 3 is a perspective view of the vehicle roof cover of FIG. 2 showing the center foam strip and downwardly extending covering material installed on the four door car with the trunk open showing the back securing strip in place to be secured under the vehicle trunk;

FIG. 4 is a perspective view of the vehicle roof cover of the present invention showing the center foam strip and downwardly extending covering material installed on a two door car showing the car door holding down a portion of the side covering material held by the door and the windshield wipers holding down a front portion of the center foam strip;

FIG. 5 is a perspective view of the vehicle roof cover of FIG. 4 showing the center foam panel and downwardly extending covering material installed on the two door car with the door open and windshield wipers elevated to install the folding car roof cover and showing the side covering strip in place to be secured under the vehicle door and the front bottom of the center foam panel in place to be secured by the windshield wipers;

FIG. 6 is a top plan view of the parts of the vehicle roof cover of the present invention showing the center foam strip and downwardly extending covering material and back securing strip aligned for assembly;

FIG. 7 is a perspective view of the center foam strip of the vehicle roof cover of the present invention showing the center foam strip partially folded up;

FIG. 8 is a cross sectional view taken through one panel of the center foam strip of the vehicle roof cover of the present invention showing the inner layer of Polyethylene closed cell foam covered by an aluminum foil layer on the upper face;

FIG. 9 is a perspective view of a storage bag containing the folded up car roof cover of the present invention;

FIG. 10 is a perspective view of a portion of the center foam strip of the vehicle roof cover of the present invention showing an edge strip partially installed around the edges of the center foam strip;

FIG. 11 is a perspective view of a portion of the center foam strip of the vehicle roof cover of the present invention showing an edge strip installed around the edges of the center foam strip;

FIG. 12 is a perspective view of a portion of the center foam strip of the vehicle roof cover of the present invention showing an edge strip installed around the edges of the center foam strip and a portion of the vehicle covering material attached to the center foam strip.

### DETAILED DESCRIPTION OF THE INVENTION

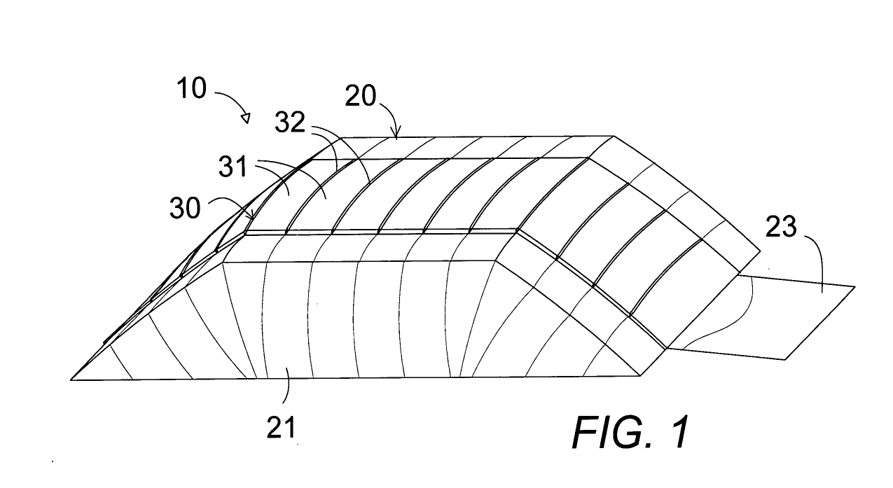

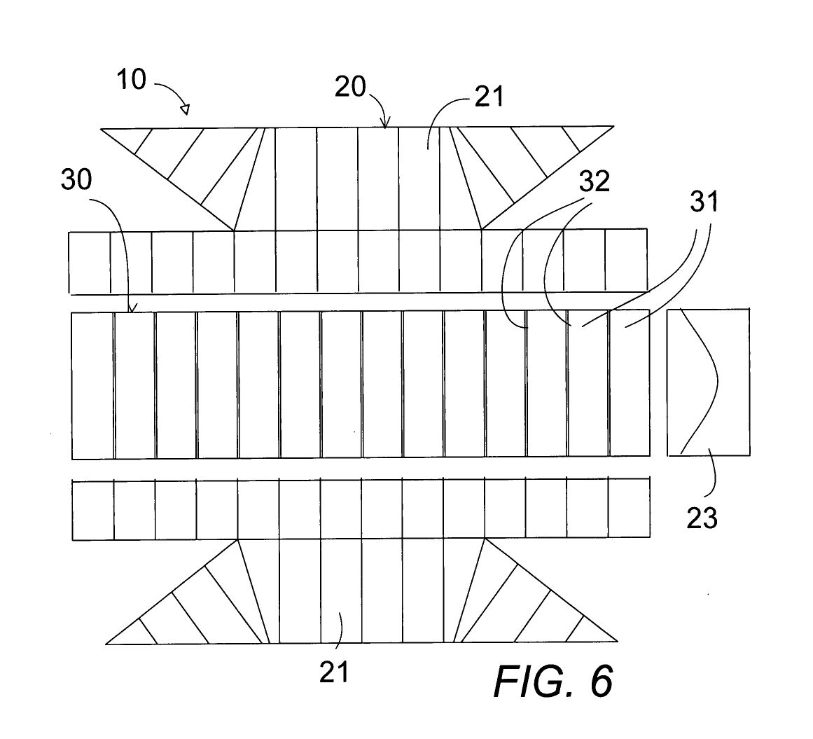

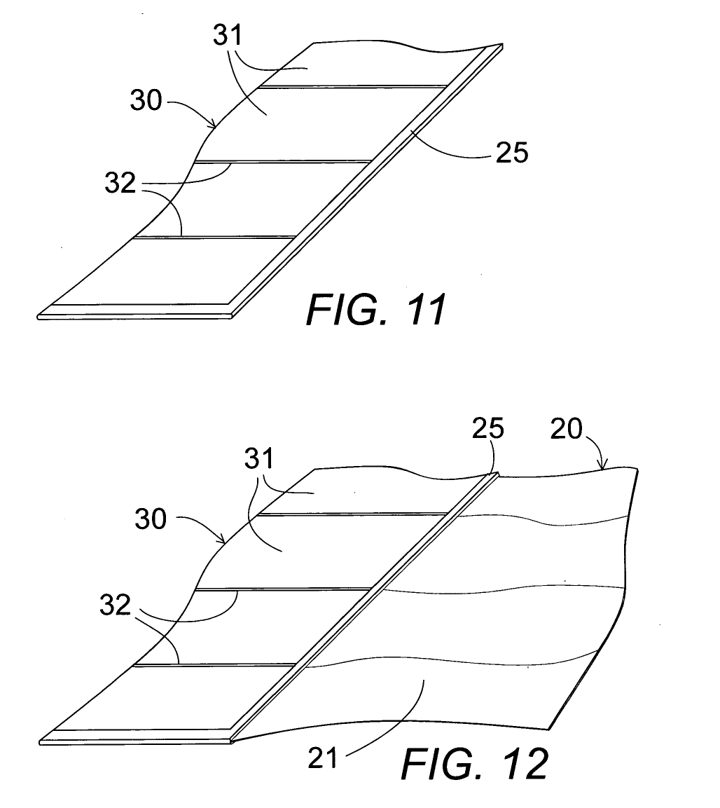

In FIGS. 1-12, a vehicle folding roof cover 10 comprises a center foam strip 30 for covering at least a center portion of the roof, the front windshield, and the back window on a vehicle 50 and a thin waterproof fabric covering material 20 attached to the side edges of the center foam strip and extending downwardly to be secured inside the doors 51 of the vehicle.

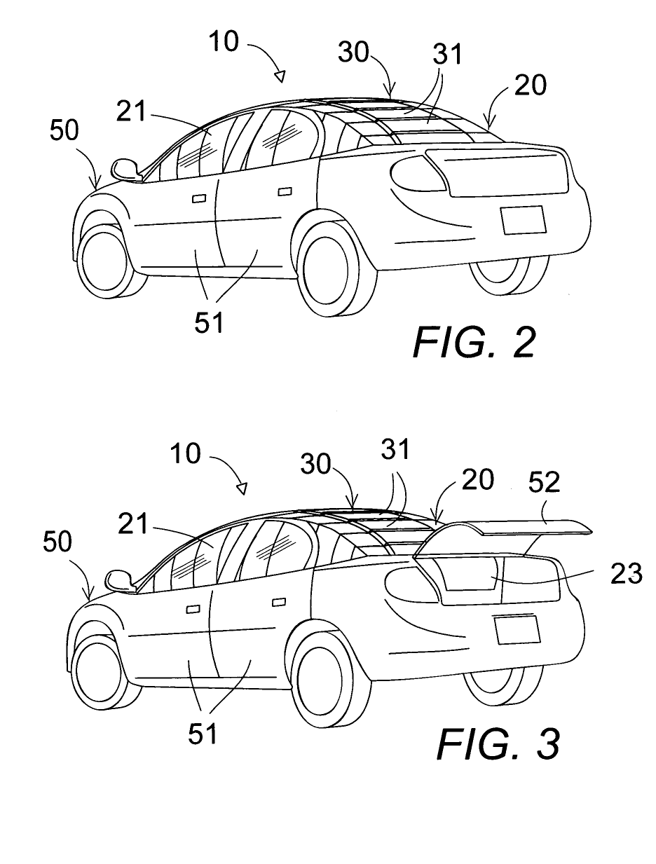

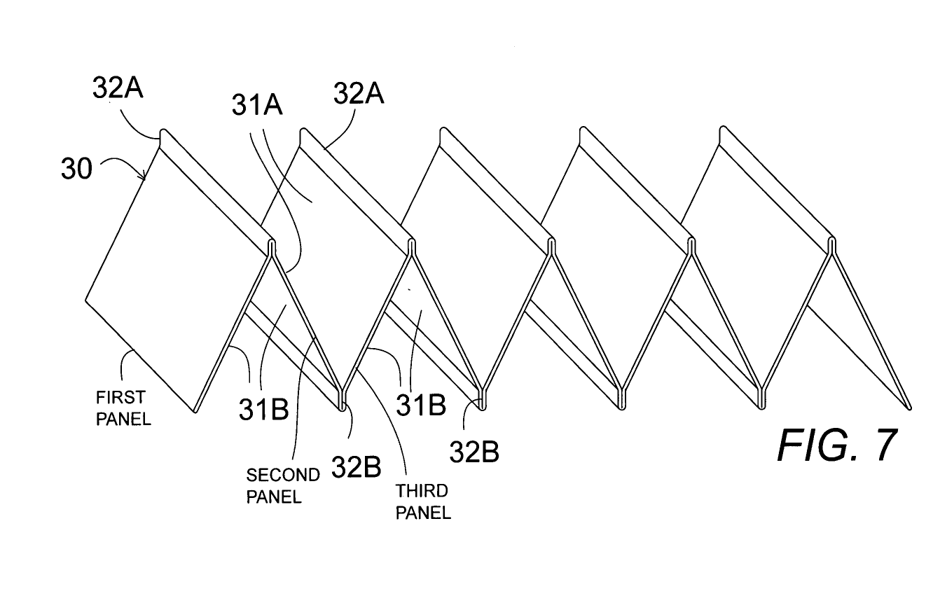

The center foam strip 30 lays flat on a vehicle 50 in a first configuration from a bottom of a front windshield on a vehicle up over at least a center portion of the windshield and over at least a center portion of the vehicle roof from front to back and over at least a center portion of a vehicle back window from top to bottom, as shown in FIGS. 2-5 to shield the vehicle windshield, the vehicle roof, and the vehicle back window from the sun and from objects landing on the vehicle and to serve as temperature insulation. The center foam strip comprising a series of planar foam panels 31, each extending across the width of the center foam strip and each bottom face of each panel facing down toward the vehicle. Each adjacent pair of foam panels 31 is interconnected by a folding connection 32 therebetween to form accordion pleats along the length of the center foam strip so that the entire center foam strip folds up for storage in a second configuration, shown partially folded in FIG. 7, with an upper face 31A of a first panel contacting an upper face of a second panel adjacent to the first panel and a bottom face 31B of the second panel contacting a bottom face of a third panel adjacent to the second panel in a repeated folded up accordion array along the length of the center foam strip.

In FIG. 7, the folding connection 32A and 32B between adjacent planar foam panels is formed by forming an overlapping interconnection of adjacent panels along the length of the folding connection alternating between an upwardly extending overlapping interconnection folding connection 32A between a first panel and a second panel adjacent to the first panel to be folded with a bottom face 31B of the first panel contacting a bottom face 31B of the second panel and a downwardly extending overlapping interconnection folding connection 32B between the second panel and a third panel adjacent to the second panel to be folded with an upper face 31A of the second panel contacting an upper face 31A of the third panel in a repeated folded up accordion array along the length of the center foam strip.

The overlapping interconnection folding connections 32A and 32B may be formed using an adhesive to secure the adjacent edges of panels together with the edges overlapping, or at least one line of stitching securing the adjacent edges of panels together with the edges overlapping.

The folding connections between the panels 32 may alternately be formed by a compressed transverse linear portion of the foam material between the panels wherein the compressed transverse linear portion may be formed by a layer of material thinner than the foam panels to allow bending between the panels, or the compressed transverse linear portion may be formed by at least one line of stitching in the foam to compress the foam to allow bending between the panels.

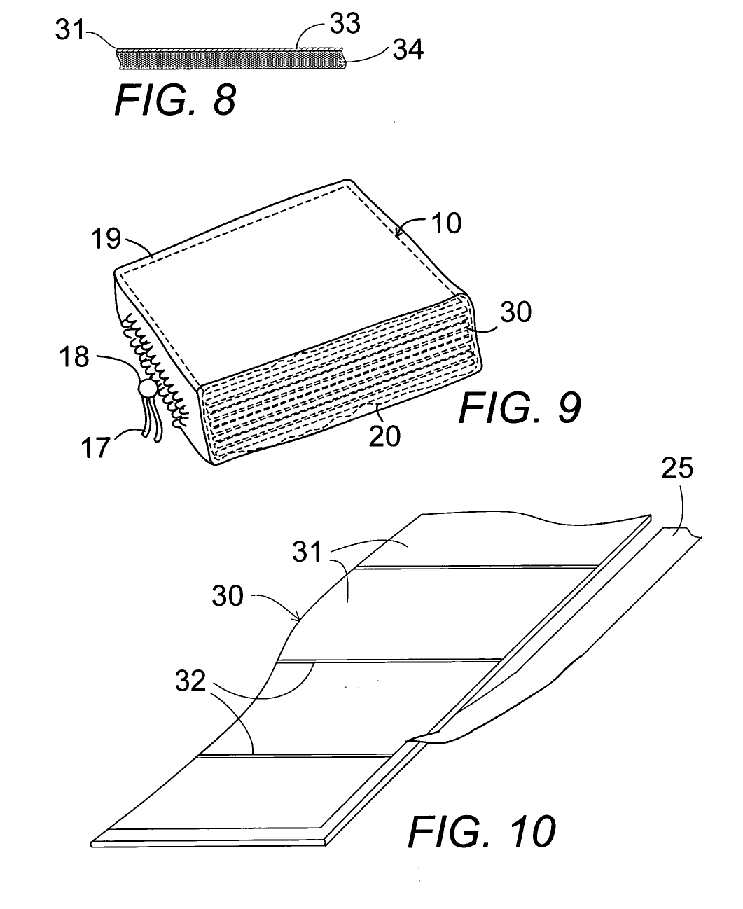

In FIG. 8, a center foam strip panel 31 is shown fabricated of Polyethylene closed cell foam 34 covered by an aluminum foil layer 33 on the upper face.

A vehicle covering material 20 is attached to the center foam strip by stitching or adhesive or heat sealing. The vehicle covering material extends down in side panels 21 from each side of the center foam strip 30 and fitting under a top portion of side doors 51 of the vehicle 50, as shown in FIGS. 2-5, to secure the vehicle covering material to the vehicle in the first configuration. The covering material side panels 21 extend down inside the doors 51 a sufficient distance to extend down the height of the side windows of the vehicle to shade an interior of the vehicle.

The covering material 20 preferably comprises a waterproof material, such as umbrella fabric, sufficiently thin to fit between a vehicle door 51 and a surrounding frame of the vehicle with the vehicle door closed to secure the covering material in place on the vehicle in the first configuration and the covering material 20 folded around the folded up center foam panel 30 or over the foam panel prior to folding for storage in the second configuration to fit inside a storage container 19, such as a bag with a cord 17 and locking knob 18 closure as shown in FIG. 9, to be stored inside the vehicle.

In FIGS. 1, 3, and 6, a securing strip 23 of covering material extends below the back window of the vehicle to fit into a trunk of the vehicle between a trunk lid 52 and a surrounding vehicle frame to further secure the covering material 20 and the center foam strip 30 in place on the vehicle.

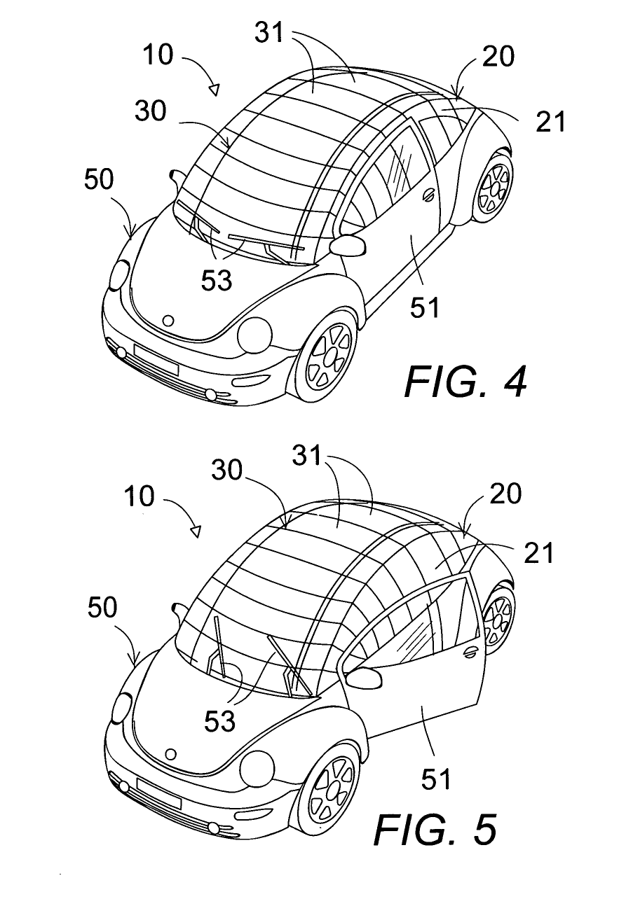

The center foam strip adjacent to a bottom of the vehicle windshield is configured with sufficiently thin foam to receive a pair of windshield wipers 53 resting thereon to further secure the center foam strip in place on the vehicle, as shown in FIG. 4.

In use, the folding car roof cover 10 of the present invention is stretched out over the roof, windshield, and rear window of a vehicle 50 with the vehicle doors 51 and trunk lid 52 open and the windshield wipers 52 elevated and the side panels 21 hanging down over the open doorways and the back securing strip 23 hanging into the open trunk. The trunk lid 53 is closed down over the securing strip 23, the doors 51 are closed over the side panels 21, and the windshield wipers 52 are lowered down on the center foam strip 30 to secure the folding vehicle roof cover to the vehicle to protect the vehicle while parked. To store the folding vehicle roof cover 10, the doors 51 are opened, the trunk lid 53 raised, and the windshield wipers 52 elevated and the center foam strip 30 simultaneously lifted off the roof and folded into an accordion folding pattern with the cover material 20 folded around it and both stuffed into a storage bag 19 for storage in the trunk or passenger compartment of the vehicle for driving the vehicle. Alternately, the cover material may be folded over the foam panel prior to folding the panel.

It is understood that the preceding description is given merely by way of illustration and not in limitation of the invention and that various modifications may be made thereto without departing from the spirit of the invention as claimed.

What is claimed is:

1. A vehicle roof cover comprising:
a center foam strip laying flat on a vehicle in a first configuration from a bottom of a front windshield on a vehicle up over at least a center portion of the windshield and over at least a center portion of the vehicle roof from front to back and over at least a center portion of a vehicle back window from top to bottom to shield the vehicle windshield, the vehicle roof, and the vehicle back window from the sun and from objects landing on the vehicle and to serve as temperature insulation; the center foam strip comprising a series of planar foam panels, each extending across the width of the center foam strip and each bottom face of each panel facing down toward the vehicle, each adjacent pair of foam panels interconnected by a folding connection therebetween to form accordion pleats along the length of the center foam strip so that the entire center foam strip folds up for storage in a second configuration with an upper face of a first panel contacting an upper face of a second panel adjacent to the first panel and a bottom face of the second panel contacting a bottom face of a third panel adjacent to the second panel in a repeated folded up accordion array along the length of the center foam strip;
a vehicle covering material attached to the center foam strip, the vehicle covering material extending down from each side of the center foam strip and fitting under a top portion of side doors of the vehicle to secure the vehicle covering material to the vehicle, the covering material extending down inside the doors a sufficient distance to extend down the height of the side windows of the vehicle to shade an interior of the vehicle, the covering material comprising a waterproof material sufficiently thin to fit between a vehicle door and a surrounding frame of the vehicle with the vehicle door closed to secure the covering material in place on the vehicle in a first configuration and the covering material folded up with the center foam panel for storage in a second configuration.

2. The vehicle roof cover of claim 1 further comprising a securing strip of covering material extending below the back window of the vehicle to fit into a trunk of the vehicle between a trunk lid and a surrounding vehicle frame to further secure the covering material and the center foam strip in place on the vehicle.

3. The vehicle roof cover of claim 1 wherein at least a portion of the center foam strip adjacent to a bottom of the vehicle windshield is configured to receive a pair of windshield wipers resting thereon to further secure the center foam strip in place on the vehicle.

4. The vehicle roof cover of claim 1 wherein the center foam strip is fabricated of Polyethylene closed cell foam covered by an aluminum foil layer on the upper face.

5. The vehicle roof cover of claim 1 wherein folding connection between adjacent planar foam panels is formed by forming an overlapping interconnection of adjacent panels along the length of the folding connection alternating between an upwardly extending overlapping interconnection folding connection between a first panel and a second panel adjacent to the first panel to be folded with a bottom face of the first panel contacting a bottom face of the second panel and a downward extending overlapping interconnection folding connection between the second panel and a third panel adjacent to the second panel to be folded with an upper face of the second panel contacting an upper face of a third panel in a repeated folded up accordion array along the length of the center foam strip.

6. The car roof cover of claim 5 wherein the overlapping interconnections comprise an adhesive securing the adjacent edges of panels together with the edges overlapping.

7. The car roof cover of claim 5 wherein the overlapping interconnections comprise at least one line of stitching securing the adjacent edges of panels together with the edges overlapping.

8. The car roof cover of claim 1 wherein the folding connection between the panels is formed by a compressed transverse linear portion of the foam material between the panels.

9. The car roof cover of claim 8 wherein the compressed transverse linear portion is formed by a layer of material thinner than the foam panels to allow bending between the panels.

10. The car roof cover of claim 8 wherein the compressed transverse linear portion is formed by at least one line of stitching in the foam to compress the foam to allow bending between the panels.

11. The car roof cover of claim 1 further comprising a container for receiving the center foam panel and cover material in the folded second configuration for storage in the vehicle.
